(19) United States
(12) Patent Application Publication
(10) Pub. No.: US 2007/0042846 A1
(43) Pub. Date: Feb. 22, 2007

(54) Floor treating machine with improved rotary drive

(76) Inventor: Johannes Petrus Van Vliet, Alphen A/D Rijn (NL)

Correspondence Address: YOUNG & THOMPSON, 745 SOUTH 23RD STREET, 2ND FLOOR, ARLINGTON, VA, 22202, US

(21) Appl. No.: 11/206,809

(22) Filed: Aug. 19, 2005

(51) Int. Cl. F16H 7/00

(52) U.S. Cl. 474/88; 474/89

(57) ABSTRACT

A floor treating machine, comprising a frame, a housing which is attached to the frame in such a manner that said housing is rotatable about a substantially vertical axis, at least three heads attached to the housing in such a manner that said heads are rotatable about corresponding substantially vertical axes, said heads being provided, on their bottom surface, with treating means and/or coupling means for treating means to be coupled to, a power source, the shaft of which is concentric with respect to the vertical axis of the frame, which shaft is in driving interaction with the housing and the heads by means of respective transmissions, wherein the transmission between the Same and the housing comprises at least two belt/pulley drives which are arranged in series, whereby said at least two belt/pulley drives are arranged in series between the frame and at least one of the heads.

The invention is a related to floor treating machine, comprising a frame, a housing which is attached to the fame in such a manner that said housing is rotatable about a substantially vertical axis, at least three heads attached to the housing in such a manner that said heads are rotatable about corresponding substantially vertical axes, said heads being provided, on their bottom surface, with treating means and/or coupling means for treating means to be coupled to, and a power source, the shaft of which is concentric with respect to the vertical axis of the frame, which s is in driving interaction with the housing and the heads by means of respective transmissions, wherein the transmission between the frame and the housing comprises at least two belt/pulley drives which are arranged in series.

Such a floor treating machine is disclosed in the international patent application WO-A-0187540. Said prior art floor treating machine comprises two belt/pulley drives which are arranged in series between a pulley on the motor shaft, and a pulley on the housing The pulleys have vastly different diameters, so as to obtain an appreciable reduction in the rotational velocities between the motor shaft and the housing. Thereby, the desired relatively low rotational velocity of the housing is obtained, in combination with the desired relatively high rotational velocity for the heads.

Although said floor treating machine performs reasonably well, it is less desirable to have a direct drive connection between the motor shaft and the housing, The object of the invention is therefore to provide a floor treating machine of the kind described before which does not have that this drawback Said object is achieved in that said at least two belt/pulley drives are arranged in series between the frame and at least one of the heads.

In the floor treating machine according to the invention, the drive for rotating the housing is obtained indirectly from one of the heads. Moreover, an appreciable reduction can be obtained by two sets of pulley drives, having pulleys with different diameter. A further advantage of the dual belt/pulley drives can be seen in the ability of such a layout to accommodate transient loadings. For instance, in case a relatively rough floor is being treated, it may occur that one or more of the heads is slowed down. In such instances, the overall behaviour of the floor treating machine according to the invention is not disturbed significantly. Moreover, such layout is less prone to damages as a result of the resiliency of the dual belt/pulley layout and shocks caused by alternating push and pull forces in the belts. A further advantage is related to the wide range of possibilities for selecting different transmission ratios.

In particular, the two belt/pulley drives which are arranged in series may comprise a fame pulley which is connected to a frame and which is coaxial with respect to the housing axis, a first intermediate pulley, a first belt being arranged around said frame pulley and said first intermediate pulley, a second intermediate pulley coaxially connected to the first intermediate pulley, an auxiliary head pulley coaxially connected to one of the heads, as well as a second belt which is arranged around said second intermediate pulley and the auxiliary head pulley. The diameter of the first intermediate pulley may be smaller than the diameter the second intermediate pulley so as to obtain the desired reduction in rotational speeds.

Furthermore the heads may each comprise a head pulley and a drive pulley which is connected to the shaft of the power source. A belt is arranged around said head pulleys and the drive pulley. Additionally, the frame may carry a cover which surrounds the housing and the at least two belt/pulley drives which are arranged in series.

The invention will not be described further with the reference to the embodiment shown in the accompanying drawings.

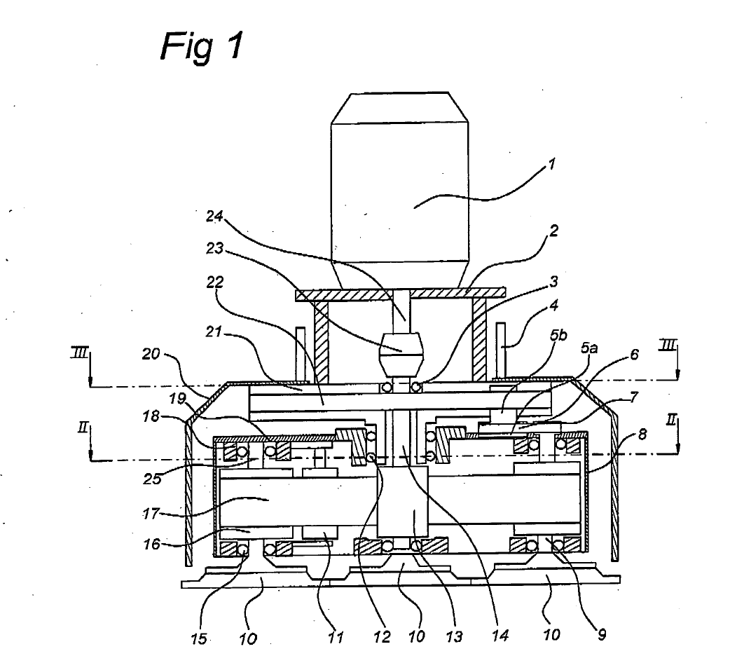

FIG. 1 shows a vertical cross-section trough the floor treating machine according to the invention.

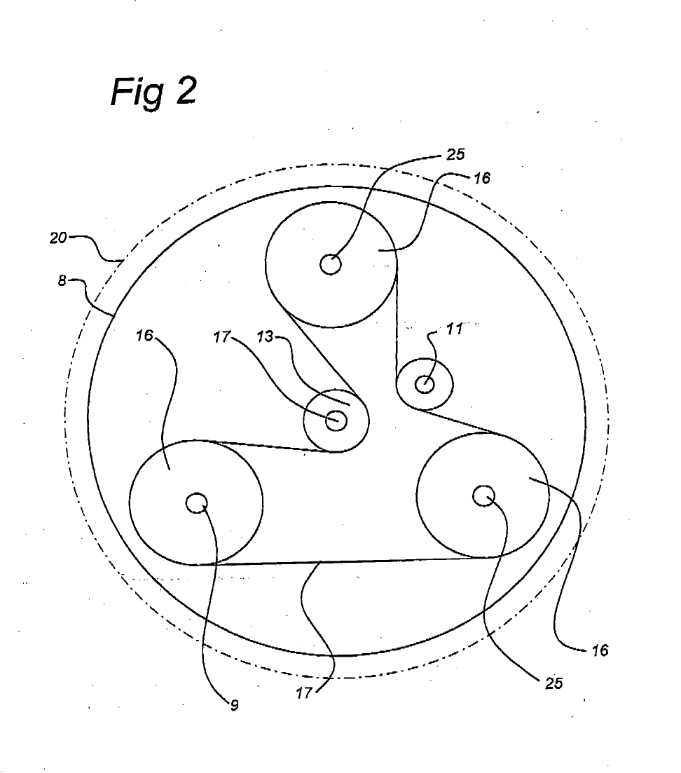

FIG. 2 shows the section according to II-II of FIG. 1.

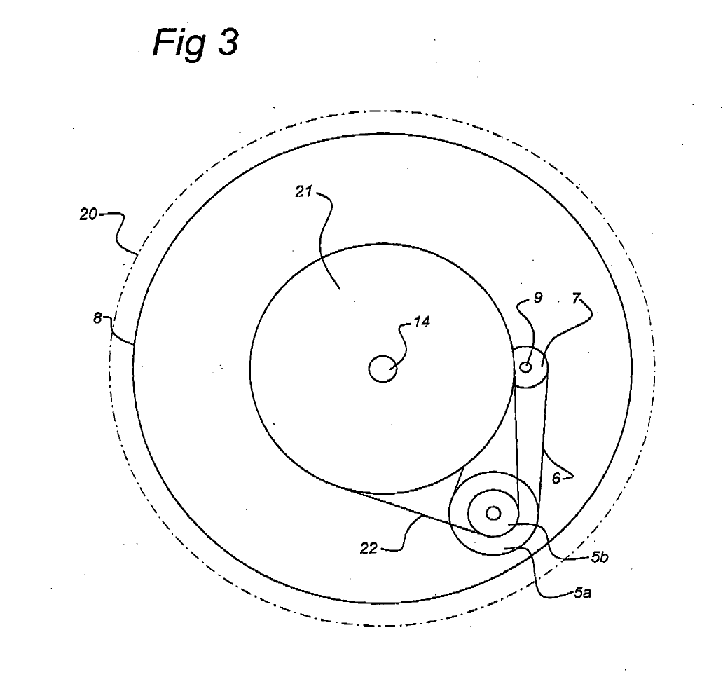

FIG. 3 shows the section according to III-III of FIG. 1.

The floor treating machine as shown in the figures comprises a housing 8, which by means of the bearings 12 is rotatably supported with respect to the Fame 20. The frame 20 carries a motor support 2, carrying the electric motor 1. The motor shaft 24 extends with a coupling 23 downwards towards and into the fame 20. By means of the centring bearing 3, said motor shaft 24 is centered with respect to the frame 20.

The lower end of the motor shaft 24 carries a drive pulley 13. Within the housing 8, three heads 10 are rotatably supported by means of their shafts 25 and an upper bearing 18 and a lower bearing 15. Between said bearings 15, 18, each head carries a head pulley 16. At the bottom side, each head 10 is provided with a holder for e.g. diamond discs. A belt 17 is arranged around the head pulleys 16, the drive pulley 13 and an idler roller 11. The idler roller 11 serves for tensioning the belt 17.

The frame 20 furthermore cares a fame pulley 21. One of the pulley shafts 25 has been extended upwardly trough the upper plate 19 of the housing 8, and caries an auxiliary head pulley 7. Furthermore, a second intermediate pulley 5a and a coaxial first intermediate pulley 5b have been provided, which are connected to each other and which are rotatably supported on top of the upper plate 19 of the housing 8. A first belt 22 is arranged around the frame pulley 21 and the first intermediate pulley 5b. A second belt 6 is arranged around the second intermediate pulley 5a and the auxiliary head pulley 7 which is connected to the part of the pulley shaft 25 which protrudes through the plate 19 of the housing 8.

In operation, the motor 1 drives the heads 10 through the drive belt 17, as shown in the view of a FIG. 2. Simultaneously, the auxiliary head pulley 7 which protrudes above the upper plate 19 on the housing 8 is rotated, setting the second intermediate pulley 5a in rotation through the second belt 6. In turn, the fist intermediate pulley 5b is set in rotation through its connection with the second intermediate pulley 5a. As a result of the fact that around this first intermediate pulley 5b a first belt 22 is guided which is also guided over the stationary frame pulley 21, said first intermediate pulley 5b is compelled. to rotate itself on the first pulley belt 22. The first intermediate pulley belt 5b being coupled to the housing 8, said housing 8 is set in rotation with respect to the frame 20 as well.

1. Floor treating machine, comprising a frame (20), a housing (8) which is attached to the frame (20) in such a manner that said housing (8) is rotatable about a substantially vertical axis, at least three heads (10) attached to the housing (8) in such a manner that said heads (10) are rotatable about corresponding substantially vertical axes (25), said heads (10) being provided, on their bottom surface, with treating means and/or coupling means for treating means to be coupled to, a power source (1), the shaft (24) of which is concentric with respect to the vertical is in driving interaction with the housing (8) and the heads (10) by means of respective transmissions, wherein the transmission between the frame (20) and the housing (8) comprises at least two belt/pulley drives (5a. 5b, 6, 7, 21, 22) which are arranged in series, characterized in that said at least two belt/pulley drives are arranged in series between the frame (20) and at least one of the heads (10).

2. Floor treating machine according to claim 1, wherein the two belt/pulley drives (5a, 5b, 6, 7, 21, 22) which are arranged in series comprise a frame pulley (21) which is connected to the frame (20) and which is coaxial with respect to the housing axis, a first intermediate pulley (5b), a first belt (22) being arranged around said frame pulley (21) and said first intermediate pulley (5b), a second intermediate pulley (5a) coaxially connected to the first intermediate pulley (5b), an auxiliary head pulley (7) coaxially connected to one of the heads (10), as well as a second belt (6) which is arranged around said second intermediate pulley (5a) and the auxiliary head pulley (7).

3. Floor treating machine according to claim 2, wherein the diameter of the first intermediate pulley (5b) is smaller than the diameter the intermediate pulley (5a).

4. Floor treating machine according to claim 1, wherein the heads (10) each comprise a head pulley (16), a drive pulley (13) being connected to the shaft (24) of the power source (1) and a belt (17) being arranged around said head pulleys (16) and the drive pulley (16).

5. Floor treating machine according to claim 1, wherein the frame (20) carries a cover with surrounds the housing (8) and the at least two belt/pulley drives (5a, 5b, 6, 7; 21, 22) which are arranged in series.

6. Floor treating machine according to claim 2, wherein the heads (10) each comprise a head pulley (16), a drive pulley (13) being connected to the shaft (24) of the power source (1) and a belt (17) being arranged around said head pulleys (16) and the drive pulley (16).
